(19) United States
(12) Patent Application Publication
(10) Pub. No.: US 2018/0074564 A1
(43) Pub. Date: Mar. 15, 2018

(54) REVERSE HIGH-VOLTAGE POWER TRANSFER

(71) Applicant: QUALCOMM Incorporated, San Diego, CA (US)

(72) Inventors: Georgios Konstantinos PAPARRIZOS, Foster City, CA (US); Varaprasad ARIKATLA, San Jose, CA (US); Giuseppe PINTO, San Francisco, CA (US); Christian SPORCK, Campbell, CA (US)

(21) Appl. No.: 15/287,685

(22) Filed: Oct. 6, 2016

Related U.S. Application Data
(60) Provisional application No. 62/394,131, filed on Sep. 13, 2016.

(51) Int. Cl. G06F 1/26; H02J 7/00; H02J 9/06; H02M 7/04

(52) U.S. Cl. CPC G06F 1/266; H02M 7/04; H02J 9/06; H02J 7/0052

(57) ABSTRACT

A first portable or non-portable device enters an adaptive charging mode to deliver a programmable output voltage to a second (e.g., sink) device, independent of a connector between the devices. The adaptive charging mode enables a sink device to detect current and voltage capability of the portable or non-portable device. It is determined whether a first device coupled to the second device through a reconfigurable port is configured as a source device or sink device. A current limit of the source device is then detected. A programmable voltage from the source device is requested based on the detecting.

### CROSS-REFERENCE TO RELATED APPLICATION

The present application claims the benefit of U.S. Provisional Patent Application No. 62/394,131, filed on Sep. 13, 2016, and titled “REVERSE HIGH-VOLTAGE POWER TRANSFER,” the disclosure of which is expressly incorporated by reference herein in its entirety.

### TECHNICAL FIELD

The present disclosure generally relates to integrated circuits (ICs). More specifically, the present disclosure relates to a portable or non-portable device that enters an adaptive charging mode to deliver a programmable output voltage and output current profile, to one or more slave (or sink) devices, independent of the connector between the devices, and to enable the one or more sink devices to detect current and voltage capability of the portable or non-portable device.

### BACKGROUND

Many modern electronic systems rely on one or more batteries for power. The batteries are recharged, for example, by connecting the system to a power source (e.g., an alternating current (AC) power outlet) via a power adapter and cable. As these modern electronic systems, including mobile computing devices (e.g., smart phones, computer tablets, and the like), continue to be used more widely, the need for fast charging of batteries becomes more significant. Advancements in fast battery charging techniques, however, are currently limited to one direction only.

### SUMMARY

According to one aspect of the present disclosure, a method for power management includes determining whether a first device coupled to a second device through a reconfigurable port is configured as a source device or a sink device. The method also includes detecting a current limit of the source device. The method further includes requesting a programmable voltage from the source device based on the detecting.

According to another aspect of the present disclosure, a method for power management includes determining whether a first device coupled to a second device through a reconfigurable port is configured as a source device or a sink device. The method also includes receiving a request for a programmable voltage from the sink device, the request based at least in part on a current limit of the source device. The method further includes sending the programmable voltage, while in reverse power mode, to the sink device in response to the request from the sink device.

Another aspect discloses an apparatus for wireless communication and includes a memory and at least one processor coupled to the memory. The processor(s) is configured to determine whether a first device coupled to a second device through a reconfigurable port is configured as a source device or a sink device. The processor(s) is also configured to detect a current limit of the source device. The processor(s) is further configured to request a programmable voltage from the source device based at least in part on the detecting.

Another aspect discloses an apparatus for wireless communication and includes a memory and at least one processor coupled to the memory. The processor(s) is configured to determine whether a first device coupled to a second device through a reconfigurable port is configured as a source device or a sink device. The processor(s) is also configured to receive a request for a programmable voltage from the sink device, the request based on a current limit of the source device. The processor(s) is further configured to send the programmable voltage, while in reverse power mode, to the sink device in response to the request from the sink device.

This has outlined, rather broadly, the features and technical advantages of the present disclosure in order that the detailed description that follows may be better understood. Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

For a more complete understanding of the present disclosure, reference is now made to the following description taken in conjunction with the accompanying drawings.

FIGS. 1A to 1C are schematic diagrams of printed circuit board (PCB) level arrangements according to aspects of the present disclosure.

FIG. 2 shows a general view of a charging circuit in accordance with the present disclosure.

FIG. 3 shows a single-phase configuration of a charging circuit in accordance with aspects of the present disclosure.

FIGS. 4A to 4C show dual-phase configurations of charging circuits according to aspects of the present disclosure.

FIG. 5 illustrates an example implementation of an electronic device (e.g., slave or sink device) for implementing an adaptive charging mode according to aspects of the present disclosure.

FIG. 6A illustrates a high-voltage or high-current charging system for implementing an adaptive charging mode according to aspects of the present disclosure.

FIG. 6B illustrates a high-voltage or high-current charging implementation for a single sink device according to aspects of the present disclosure.

FIG. 6C illustrates a high-voltage or high-current charging implementation for a multiple sink devices according to aspects of the present disclosure.

FIG. 6D illustrates another high-voltage or high-current charging system for non-portable device implementation of an adaptive power transfer mode according to aspects of the present disclosure.

FIG. 7 is a process flow diagram illustrating a method of concurrently charging a battery and powering a peripheral device according to an aspect of the present disclosure.

FIG. 8 is a process flow diagram illustrating another method of concurrently charging a battery and powering a peripheral device according to an aspect of the present disclosure.

FIG. 9 is a block diagram showing an exemplary wireless communication system in which a configuration of the disclosure may be advantageously employed.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. It will be apparent to those skilled in the art, however, that these concepts may be practiced without these specific details. In some instances, well-known structures and components are shown in block diagram form in order to avoid obscuring such concepts. As described herein, the use of the term “and/or” is intended to represent an “inclusive OR”, and the use of the term “or” is intended to represent an “exclusive OR”.

Power specifications for modern mobile devices or portable electronics are increasing very rapidly (e.g., larger displays, long term evolution (LTE) radio, multi-core processors, etc.). Mobile devices specify higher capacity batteries (amp-hour) and batteries allowing higher charge rates (C rate) to maintain acceptable charge times. In such modern mobile devices, battery charging times are very long when traditional power sources are used. To reduce the battery charging times, many high-voltage and/or high-current charging technologies have been introduced. For example, some technologies allow for higher voltage levels to address headroom and other issues limiting charging times. Some other technologies allow for low-voltage/higher current and more direct battery access/connection to address system impedance losses and other issues limiting charging times. For many applications, it is very beneficial to integrate such functionality in the main charger or power management integrated circuit (PMIC) and use host mode that incorporate a reverse power mode (e.g., on-the-go (OTG) mode), or other modes, such as dual role mode based on USB PD specifications, to deliver such higher voltage or higher current levels via direct charge. Conventionally, a mobile device provides fixed voltage (e.g., 5V) in the reverse boost mode. In this mode the mobile device becomes a host.

Aspects of the present disclosure are directed to adaptive charging mode (e.g., adaptive boost or buck mode) implementations in existing circuits used in mobile devices or non-portable devices and other portable applications. The portable or non-portable devices and/or the peripheral devices for performing the adaptive charging mode implementation are referred to as adaptive charging mode devices. For example, a power management integrated circuit inside a portable or non-portable device enters the adaptive charging mode (e.g., boost, buck and/or bypass mode) to deliver a programmable output voltage profile (to address different high-voltage or low-voltage/high-current specifications of different devices on the market), to one or more sink devices, independent of the connector between the devices, and to enable the sink device (power receiver) to detect current and/or voltage capabilities of the source device or host.

The adaptive charging mode (e.g., bypass mode) may be associated with a configuration of a field effect transistor (s) (FET(s)) of the portable or non-portable device. For example, the transistors of the portable or non-portable device may be selectively and/or dynamically turned on or off to achieve the adaptive charging mode. In the bypass mode the battery supplies power (e.g., voltage and/or current) to the system. For example, the battery provides power to a peripheral device (e.g., external device coupled to a mobile device) and/or a load (e.g., an internal device of the user equipment (UE) such as an LED flash device.)

It is to be noted that the voltage profile may include voltages supported by USB PD and other protocols, including 5V, 12V, 20V, as well as other voltages including 3V, 6V, 9V, 11V and 15V. In addition, the voltage profile may also include voltages that are programmable to improve or optimize performance of the system in accordance with the adaptive charging mode implementations. The voltages may be programmed in steps (e.g., 10 mV, 20 mV, or any desirable step between 10 to 20 mV) to improve the performance of the system.

According to the adaptive charging mode implementation, portable or non-portable devices are adaptively or dynamically configured to provide variable or fixed low-voltage charge or high-voltage charge or to receive variable or fixed high-voltage charge based on current or present operating conditions. Accordingly, the adaptive charging mode is a dynamic charging mode implementation. For example, a portable or non-portable device may charge a reverse power mode peripheral device (e.g., an on-the-go (OTG) peripheral device) when the portable or non-portable device is configured as a host or source. Alternatively, the portable or non-portable device may receive charge (e.g., high-voltage or low-voltage/high-current charges) from the reverse power mode peripheral device when the portable or non-portable device is configured as a slave or sink. In some aspects of the disclosure, the adaptive charging implementation may be achieved independent of a power source such as an adapter. For example, the charge from the portable or non-portable device comes solely from a battery of the portable or non-portable device. Similarly, the charge from the reverse power mode peripheral device comes solely from a battery of the reverse power mode peripheral device. Thus, the adaptive charging mode is implemented as a dual role mode where the portable or non-portable device is configured as a slave or sink or as a host or a source. Similarly, the reverse power mode peripheral device may be configured as a sink or as a host/source in accordance with the dual role mode.

The adaptive charging mode implementations may be performed in accordance with a power management system (power management integrated circuit (PMIC)) of the portable or non-portable device to provide key functionality without additional integrated circuits and/or external components for configuring the portable or non-portable device as a host or sink and the peripheral device as a host or sink. The adaptive charging mode implementation improves the charging of the portable or non-portable device and the peripheral device when the peripheral device is coupled or connected to the portable or non-portable device via a port. The noted power management system also enables noted charging operation by partitioning existing circuitry on an integrated circuit (IC) rather than relying on additional circuitry.

The adaptive charging mode may be configurable and flexible to address today's market specifications. For example, some of the market specifications addressed include the ability to provide different high-voltage or low-voltage/high-current standards or implementations, interaction issues, current and voltage capability detection, multi-slave (or sink) device support, and so on. For example, aspects of the present disclosure provide variable and fixed voltage charging. For example, adaptive charging mode implementation supports fixed voltage charging where fixed voltages 5V, 9V, and 12V are provided to charge the peripheral device or the portable or non-portable device when the devices are connected together via a common port. The adaptive charging mode implementation also supports variable voltage charging where variable voltages (e.g., 3.3 V to 12 V in stepwise increments (e.g., in 20 mV increments)) are provided to charge the peripheral device or the portable or non-portable device when the devices are connected together via a common port. The variable voltages may be programmable voltages that are specific to different device specifications or to certain systems or battery conditions and states. It is to be noted that the voltage ranges and step sizes listed here are examples that may be different based on varying implementations.

The adaptive charging mode implementation may be achieved in accordance with different device specifications. Some specifications include reconfigurable ports (e.g., input and/or output ports) for connecting the portable or non-portable device to the peripheral device. The ports are reconfigurable based on the communication conditions to support the adaptive charging mode. For example, some interconnection lines of the port may be used to transmit charge to provide charge to the peripheral device when the peripheral device is configured as the sink. Alternatively, the same interconnection line may be used for data communications in a different configuration. The port may be a single connector used to provide high-voltage or low-voltage/high-current power as an input or as an output.

Some specifications (e.g., USB Type-C, USB PD, etc.) define a random process for two devices to become sink (power consumers—slaves) or source (power providers—sources). Other defined conventions exist for devices to “try” to become a source or sink dependent on the device type. For example, phones are recommended to “try” to be sinks to reduce randomness. USB Type-C is a specification for a small selected number of pins (e.g., 24-pin) reversible-plug connector for USB devices and USB cabling. For example, two devices (e.g., a portable or non-portable device and a peripheral device) can be connected together with a USB Type-C connector or port.

Conventionally, in USB Protocol (e.g., legacy USB cable that do not implement USB Power Delivery (USB PD) Protocol), data and power roles were typically fixed. For example, a shape of a receptacle/plug dictated both its data role and power role. USB Type-C connections, including USB PD, are much more flexible. The ports may be host-mode only, device-mode only, or dual-role and both the data and power roles can be independently and dynamically swapped using USB Power Delivery Protocol. However, USB Type-C configuration specifies a random process for operating a device (e.g., peripheral device or portable or non-portable device) as a slave (or sink) or a host (or source). For example, in accordance with the USB Type-C configuration, a peripheral device may be randomly specified to operate as the sink device while a mobile device is randomly specified to operate as a host or source device and vice-versa. The peripheral device may be an on-the-go (OTG) peripheral device.

Although a USB Type-C specification and corresponding USB Type-C based port for connecting the portable or non-portable device are described, other port specifications may be applicable for connecting the peripheral device to the portable or non-portable device. For example, to achieve the adaptive mode charging (e.g., reverse boost, buck or bypass mode charging), the charge (e.g., voltage, current or power) provided is independent of the communication protocol (e.g., data lines (e.g., D+/D− pins), USB PD (like Type-C detector)). For example, a USB connector includes power, ground and D+/D− interconnects, where D+/D− are the data lines.

In some aspects the peripheral (sink) device is expecting a certain behavior of the host (source) device to comply with pre-determined states as defined in USB and other specifications. For example, the host device configures the D+/D− lines to a specific state (e.g., short) to emulate a USB BC1.2 power source. The host device may also configure the D+/D− lines to a different state (example: D+=0.6V, D−=0.6V) to emulate a different, pre-determined power source state. The USB BC1.2 is a battery charging specification revision 1.2.

In some aspects of the present disclosure, D+/D− signals are used to negotiate the high-voltage or low-voltage/high-current power to be provided to charge a slave (or sink) device by a source device (or host). In other aspects of the present disclosure, the negotiation occurs through only D+ signals, only through D− signals or both. In other aspects, a USB Type-C connector is used with USB Power Delivery Protocol for communication in conjunction with other lines like CC1 and CC2. Other connectors or lines in existing connectors may also be used for providing power and for negotiating. For example, while aspects of the disclosure indicate that the negotiating occurs through D+/D− signals, the negotiating can be performed with other signals.

Aspects of the present disclosure avail this feature by defining a mode of operation where a user determines whether to operate the mobile device in accordance with a sink mode to receive charge from a peripheral device or in accordance with a source mode to provide charge to the peripheral device. Thus, the implementation achieves device-to-device charging via a connector (e.g., USB Type-C connector) that allows for determination of a mode of operation (e.g., source (source) or slave (sink)) of each of the paired or connected devices.

For example, the portable or non-portable device predetermines the mode of operation of the peripheral device and the mode of operation of the portable or non-portable device. Thus, the source and sink relationship between the portable and the non-portable device is predetermined. Thus, the direction of the power or charge is predetermined. The predetermination may occur dynamically and may be based on current operating conditions of the peripheral device and/or the portable or non-portable device. An example of the current operating condition is battery voltage or state of charge of the battery. For example, the device will be a sink when a state of charge of the battery of the device is less than fifty percent.

The source and sink relationship between the portable and the non-portable device may also be based on a combination of conditions. For example, the source and sink relationship between the portable and the non-portable devices or the adaptive mode of operation of the portable or non-portable devices may be based on a priority allocated to the portable and the non-portable devices, the state of charge of the battery, charge current, impedance (e.g., of a power supply path between the two devices) and thermal conditions of the portable or non-portable device. The impedance may be an impedance between the connection lines or devices through which the power is supplied between the portable or non-portable devices. For example, the portable and non-portable device may be prioritized as a source device or to provide power, or a sink device or to receive power. The devices may also be allocated with other communication priorities that may prevent them from operation as a source or sink under certain conditions.

The peripheral device is configured as a source device when delivering the charge and configured as a sink device when receiving the charge. In some aspects, the portable or non-portable device dynamically determines when to operate as a source device or a sink device based on current operating conditions of the portable or non-portable device and/or the peripheral device. For example, the operation conditions include a power profile of the devices. In some aspects, the portable or non-portable device may include a bigger battery and/or has more charge than the peripheral device partnered to it through the port. In this case, the portable or non-portable device with the bigger battery and/or more charge may be configured to operate as the source or source device while the peripheral device is configured to operate as a sink device. This feature can be implemented on a system level with a system controller or on a local level with a local controller or hardware. In other aspects, the devices may negotiate power transfer direction based on other conditions (pre-determined or dynamic) such as criticality of each device and others.

Some aspects of the present disclosure may be implemented in a power management circuit (e.g., power management integrated circuit (PMIC) or battery charger integrated circuit) of a portable (e.g., mobile device) or non-portable device or implemented in conjunction with a power management system of the portable or non-portable device. For example, the PMIC (with same power train) is used to implement adaptive mode charging such as reverse mode charging where the source device provides programmable output voltage or programmable current to the sink device.

According to aspects of the disclosure, the portable or non-portable device is configured to enter different modes of operation including a reverse boost or buck mode of operation, for example, to provide a charge to the peripheral device. When the portable or non-portable device is in the reverse boost or buck mode of operation, the portable or non-portable device delivers a programmable output voltage profile to one or more peripheral devices configured to operate as a sink device. For example, the other modes of operation of the portable or non-portable device include reverse buck/boost mode (buck-or-boost mode), reverse buck mode and so on.

For example, when the peripheral device is coupled or connected to a port of the portable or non-portable device, the portable or non-portable device determines whether to operate as a sink or a source. The determination of whether to operate as a source or sink is made in accordance with software implementation (e.g., algorithm steps implemented as computer software), a hardware implementation or a combination thereof. For example, a high level operating system running dual role ports (DRPs) toggles between a downstream facing port (DFP) and an upstream facing port (UFP). The toggling may occur until an attach event occurs. DRPs may be dynamically swapped using USB Power Delivery Protocol Negotiation after an initial attach event. In some configurations, power transfer may be prioritized for more than one sink device under some conditions.

In one aspect of the disclosure, the portable or non-portable device is set either as a sink device or as a source device based on software implemented on a controller or processor. For example, the setting process described herein may be achieved as computer executable code that is read and executed by a kernel process of the processor. The setting process may be performed when the portable or non-portable devices are connected to the port. The controller may be a system controller of the portable or non-portable device or a controller associated with the power management integrated circuit of the portable or non-portable device. The controller may be integrated in the power management integrated circuit or external but coupled to the power management integrated circuit. For example, the portable or non-portable device is set as a sink device when in an off or in a dead battery state and the peripheral device is coupled to a port of the portable or non-portable device. Thus, power level of the battery may be monitored to determine level of charge of a battery of the portable or non-portable device. The controller then determines a mode of operation (source or sink) of the portable or non-portable device based on the level of charge of the battery.

In one aspect of the present disclosure, the portable or non-portable device is configured to deliver a voltage specified for the peripheral device, where the voltage is selected or identified from a range of programmable voltages available to the portable or non-portable device to charge the peripheral or sink device. The voltage range may be configured to address different high-voltage or low-voltage/high-current implementations of current peripheral devices or sink devices. For example, the voltages may be range from 3.3 V-12 V and may be based on stepwise increments (e.g., 20 mV). Some of the programmable voltage values within the range include 3.320 V, 3.340 V, 3.360 V and so on. By having the different programmable voltage values, the portable or non-portable device (when configured as a source) is capable of addressing different high-voltage or low-voltage implementations of current peripheral devices or sink devices.

In one aspect of the disclosure, the portable or non-portable device is set either as a sink device or as a source device based on hardware implementation. For example, a portable or non-portable device enters an intermediate state (e.g., try sink state (Try.SNK) or try source state (Try.SRC)) based on whether a battery voltage of the portable or non-portable device fails to meet a battery voltage threshold (or battery state of charge or battery capacity). For example, intermediate states such as the try sink state and try source states are available for USB Type-C configurations.

In one aspect of the disclosure, the portable or non-portable device is set either as a sink device or as a source device based on another hardware implementation. In this hardware implementation, a switch or button attached to specific resistor values is used to select power direction. This hardware implementation is desirable for power banks and other devices.

In one aspect of the disclosure, the battery voltage threshold (e.g., under-voltage threshold) is a programmable threshold. For example, the portable or non-portable device enters the intermediate state (e.g., try sink state) when the battery voltage is lower than a programmable threshold. In the try sink state of the portable or non-portable device, the port of the portable or non-portable device queries the peripheral device partnered to the port to determine whether the peripheral device supports a source mode of operation. Meanwhile, in accordance with the try sink state, at least one or some interconnection lines of the port connecting the portable or non-portable device and the peripheral device are temporarily disconnected until the peripheral device enters a source mode of operation. For example, in the try sink state, the temporarily disconnected lines include interconnection lines to set up delivery of a charge to the portable device or interconnection lines through which the charge to the portable is to be delivered. In the try source state, the temporarily disconnected lines include interconnection lines to set up receiving of a charge from the portable device or interconnection lines through which the charge from the portable is to be received.

The device that is in the try sink state enters sink mode when it is determined (e.g., through negotiations through open interconnection lines of the port) that the peripheral device supports a source mode. For example, in the sink mode, the temporarily disconnected interconnect lines are restored and the charging of the portable or non-portable device occurs through the restored interconnect lines. In some implementations, however, if the other device does not support the source mode, the device that is implementing the try sink state returns to being a source depending on the current operating conditions. The device implementing the try sink state may stays in the try sink state when it is off or when its battery level is below a threshold.

A device that is in the try source state enters source mode when it is determined (e.g., through negotiations through open interconnection lines of the port) that the peripheral device supports a sink mode. For example, in the source mode, the temporarily disconnected interconnect lines are restored and the charging of the peripheral device occurs through the restored interconnect lines. In some implementations, however, if the other device does not support the sink mode, the device that is implementing the try source state may return to being a sink depending on the current operating conditions.

Thus, the intermediate state (e.g., try sink state or try source state) limits a random assignment of the portable or non-portable device as well as the peripheral device as a source or a sink when the devices are connected to the port (e.g., USB Type-C port).

In some aspects of the disclosure, adaptive charging mode (e.g., boost mode, buck mode, charge pump mode, bypass mode, or buck/boost mode) implementation is configured to enable the sink (power receiver) device to detect current capability of the host device. For example, when the portable or non-portable device is the sink, the portable or non-portable device can detect the current capability of the host device (e.g., peripheral device). In one aspect of the disclosure, the source device (e.g., peripheral device) provides the sink device (e.g., the portable or non-portable device) with its current capability. The sink device may then request or specify a charge from the source device based on the current capability of the source device. The charge specification or request may correspond to a current that is less than or equal to a current limit of the source device.

In some aspects of the disclosure, to determine the current capability of the host or source device, the sink device starts pulling current out of the source device. When the source device attains a specific level of current that it cannot supply anymore, the voltage of the source device starts to droop. The sink device detects the voltage corresponding to the droop and returns to a previous desirable voltage level. In this case, the sink device specifies or requests a charge that corresponds to the current that is less than or equal to the current limit of the source device or corresponds to the previous desirable voltage level.

For example, if a current limit of a source device is 500 milliamps (mA), the source device can support sink devices that specify 100 mA, 200 mA, 300 mA, up to 500 mA while maintaining a same voltage level. However, when the sink device starts to draw more current than the limit (e.g., the sink device specifies 600 mA or 700 mA), the voltage provided by the source device starts to droop. When the drooping starts to occur, the sink device identifies that a current limit has been attained and returns to the previous desirable voltage level.

In one aspect of the disclosure, the sink or peripheral device monitors the voltage supply from the source device or host. For example, the sink device may monitor the voltage to determine how low the voltage droops and the speed of the voltage droop. When the sink device detects the voltage droop, the source device automatically reduces the current that the sink device is specifying to regain a balance. In some aspects, the reduction of the current or charge is in response to the request from the sink device. The source device determines a current capability (e.g., maximum current capability) of a sink device or external power source and adjusts or causes current provided or received based on the current capability. In some implementations, the sink device determines a current capability (e.g., maximum current capability) of a source device or external power source and sets an input current limit. The source device may have many current limits, but it does not know what the sink device capability is to set the correct current limit. The limit can be advertised or an automatic input current limit method (discussed herein) can be employed. The limit advertisement and automatic input current limit method may be employed because the source device usually does not know the current limit of the sink. Instead, an output voltage of the source device droops when its current limit is reached, which will then cause the sink to determine the source's current limit and request or draw less current. In some implementations, the source device signals to the sink device that its current limit or under-voltage thresholds are attained to let the sink device scale back on power specifications.

Aspects of the present disclosure allow for removal of some devices from the source and/or sink device, reduce bill of material and board space. For example, a the present disclosure permits omission of a programmable boost or buck regulator and an interface integrated circuit (IC) to detect/negotiate a specified protocol and to inform the boost or buck regulator of the voltage to be provided. External components (e.g., discrete components) may also be omitted to support these components. The aspects of the present disclosure also improve power transfer between source and sink devices.

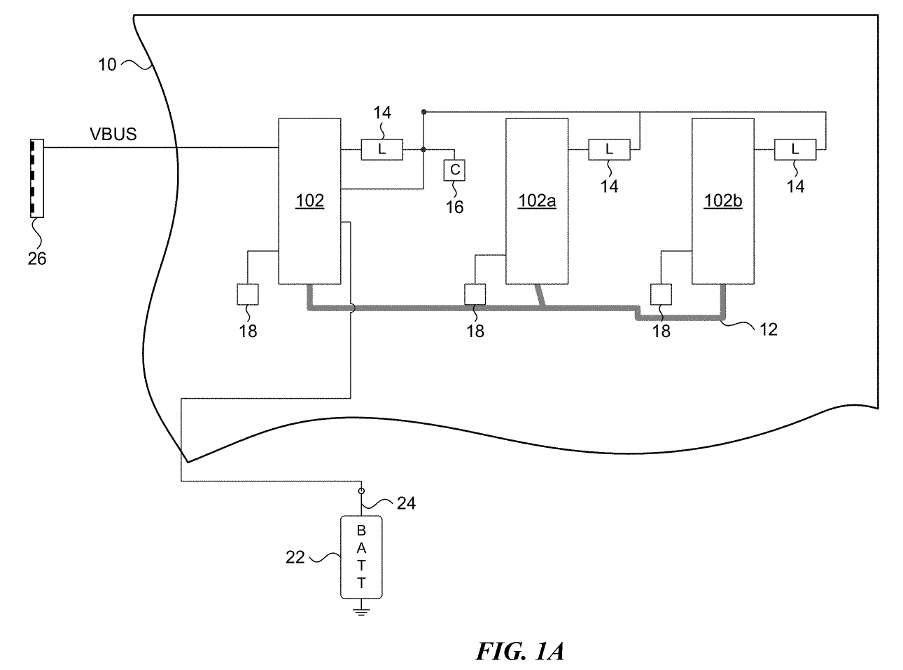

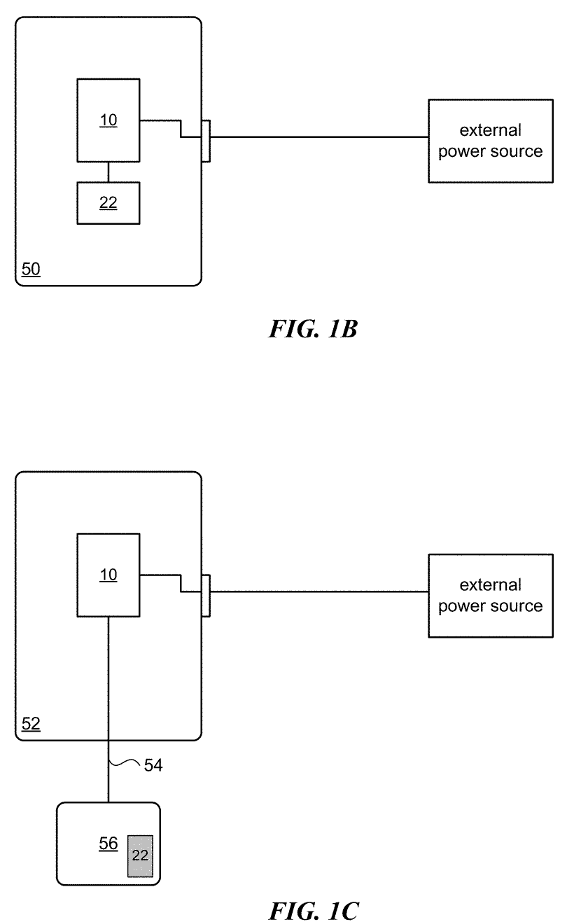

FIG. 1A shows a portion of a printed circuit board (PCB) 10 populated with battery charging devices or other devices. The PCB 10 may be a circuit board, for example, in a mobile computing device, a smart phone, and in general any electronic device. The PCB 10 may be populated with battery charging devices 102, 102a, 102b. It will be appreciated in the discussions to follow that fewer or more battery charging devices may be provided or devices other than charging devices can be provided. Each of the battery charging devices 102, 102a, 102b may be embodied in any suitable integrated circuit (IC) packaging format (e.g., single in-line packaging, dual in-line packaging, surface mount devices, and so on) and interconnected on the PCB 10. Although the devices described with respect to FIG. 1A are on the PCB 10, the devices may be on different devices according to aspects of the present disclosure. For example, the master device (host/source) may be on a first PCB while the slave (sink) device is on a different PCB according to aspects of the present disclosure. The source device (host) and the sink device may be connected by a connector such as a Type C connector.

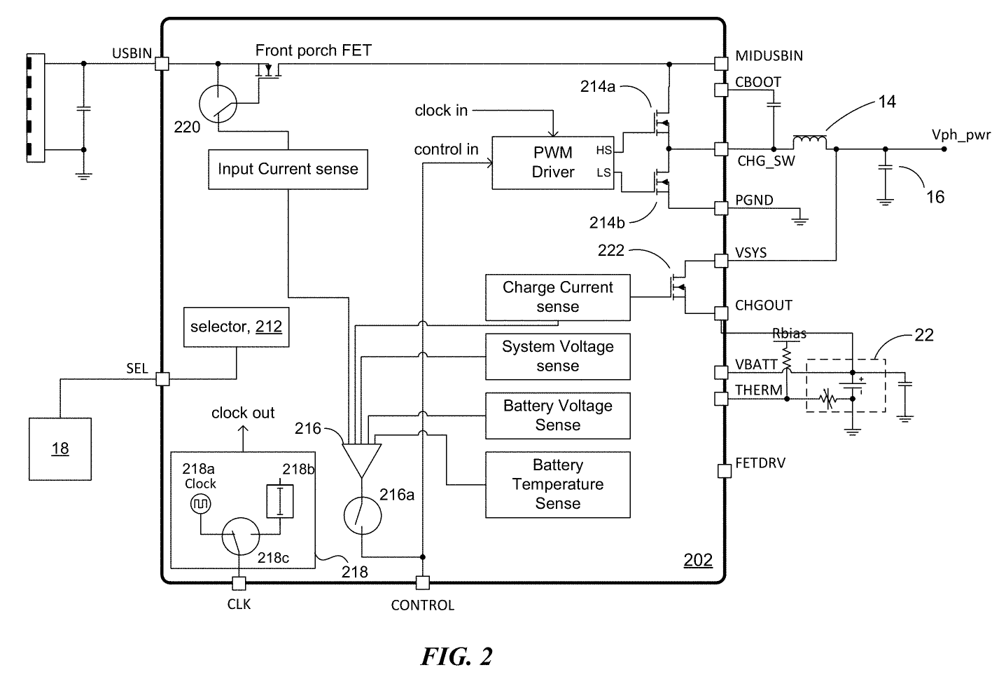

The voltage regulator module is a device configured to maintain a constant voltage level. The inductance 14 may include combined inductance of the voltage regulator module (or a surface mount technology inductance, or inductance caused by surface mount technology) in addition to parasitic inductance from the printed circuit board (shown in FIG. 2). The first capacitance 16 may include the combined capacitance from the voltage regulator module and any decoupling capacitance from any nearby components. The inductance 120 may include any trace inductance from the overall device near the second stage 114.

In some aspects, the battery charging devices 102, 102a, 102b are identical devices that can be configured for different modes of operation. For example, the device 102 may be configured for “source” or “host” mode operation, while devices 102a, 102b may be configured for “slave” or “sink” mode operation. It will be understood that battery charging devices 102, 102a, 102b may include pins or terminals (not shown) that allow the devices to be interconnected on the PCB 10 using PCB traces, represented generally by item 12.

The output device may be any device that would receive power, or that would benefit from a power delivery network, such as a two-stage power delivery network. For example, in one implementation, the output device may be a modem, an application processor or any such similar device. In one implementation, the output device is implemented as a die.

In accordance with principles of the present disclosure, the battery charging devices 102, 102a, 102b may be connected to a battery 22 via a connection 24 (e.g., battery terminal) for coordinated charging of the battery by the battery charging devices. The battery 22 may comprise any known configuration of one or more cells (e.g., a single-cell configuration, a multi-cell, multi-stack configuration, etc.) and may use any suitable chemistry that allows for recharging.

In some aspects, the battery charging devices 102, 102a, 102b operate as buck converters, and in other aspects the battery charging devices may comprise buck-boost converters (or boost converters). In some aspects, the inductive component of the buck converter may be provided as external inductive elements 14 provided on the PCB 10. Accordingly, each battery charging device 102, 102a, 102b may be connected to a corresponding external inductive element 14, such as an inductor. The inductive elements 14 are “external” in the sense that they are not part of the charging integrated circuits (ICs) that comprise the battery charging devices 102, 102a, 102b. In accordance with the present disclosure, the capacitive component of the buck converters may be provided as an external capacitive element 16 on the PCB 10 that can be shared by each battery charging device 102, 102a, 102b. The capacitive element 16 is “external” in the sense that it is not part of the charging ICs that comprise the battery charging devices 102, 102a, 102b.

Further, in accordance with the present disclosure, each battery charging device 102, 102a, 102b may be connected to a corresponding external selection indicator 18 to configure the device for source or slave mode operation. Each selection indicator 18 is “external” in the sense that it is not part of the charging IC that comprises the device. In some aspects, the selection indicator 18 may be a resistive element. For example, a connection to ground potential (e.g., approximately 0Ω) may serve to indicate the device (e.g., 102) should operate in source mode. A non-zero resistance value (e.g., 10KΩ, 100KΩ, etc.) may serve to indicate that the device (e.g., 102a, 102b) should operate in slave mode. In some aspects of the disclosure, the resistors corresponding to the zero and/or non-zero resistances are provided at or close to a connector (e.g., Type C) of the mobile device, rather than on the PCB, so that the other devices coupled or attached to the mobile device can determine the resistances to determine its mode of operation (e.g., sink or host). More generally, in other aspects, the selection indicator 18 may be a source of a suitable analog signal or digital signal that can serve to indicate to the device 102, 102a, 102b whether to operate in source mode or slave mode.

Further in accordance with the present disclosure, each battery charging device 102, 102a, 102b may be connected to a corresponding external selection indicator 18 to configure the device for source or slave mode operation. Each selection indicator 18 is “external” in the sense that it is not part of the charging IC that comprises the device. In some aspects, the selection indicator 18 may be a resistive element. For example, a connection to ground potential (e.g., approximately 0Ω) may serve to indicate the device (e.g., 102) should operate in source mode. A non-zero resistance value (e.g., 10KΩ, 100KΩ, etc.) may serve to indicate that the device (e.g., 102a, 102b) should operate in slave mode. More generally, in other aspects, the selection indicator 18 may be a source of a suitable analog signal or digital signal that can serve to indicate to the device 102, 102a, 102b whether to operate in source mode or slave mode.

Power to the battery charging devices 102, 102a, 102b may be externally provided via any suitable connector 26. Merely as an example, the connector 26 may be a USB connector. Power from the VBUS line of a USB connector may be connected to the device 102 (e.g., at a USBIN terminal), which may then distribute the power to the other devices 102a, 102b via a MIDUSBIN terminal. These and other terminals will be described in more detail below.

One of ordinary skill will appreciate that aspects of the present disclosure may include any electronic device. For example, FIG. 1B points out that the PCB 10 may be incorporated in any electronic device 50 to charge the battery 22. FIG. 1C illustrates another configuration in which the PCB 10 may be provided in a first electronic device 52 that has a connection 54 to a second electronic device 56 to charge the battery 22 in the second electronic device. In some aspects, the connection 54 may not be physical, for example, wireless energy transfer from the first electronic device 52 may be provided using magnetic induction circuitry (not shown).

The discussion will now turn to details of the battery charging device 102 in accordance with some aspects of the present disclosure. FIG. 2 shows a simplified schematic representation of the battery charging device 102. In some aspects, the battery charging device 102 may comprise a charging IC 202. It will be appreciated that in some implementations, the design of the charging IC may be implemented on two or more ICs. For purposes of discussion, however, we can assume a single charging IC implementation without loss of generality.

The charging IC 202 may comprise circuitry to provide battery charging functionality in accordance with principles of the present disclosure. In some aspects, for example, the battery charging functionality may be provided using a buck converter, a buck-boost converter, a boost converter, a charge pump, and so on. Accordingly, the charging IC 202 may include a high-side FET 214a and a low-side FET 214b that can be configured in a buck converter topology in conjunction with the inductive element 14 and the capacitive element 16.

A pulse width modulated (PWM) driver circuit may produce gate drive signals (HS, LS) at its switching output to switch the gates of respective FETs 214a and 214b. The PWM driver circuit may receive a current-mode control signal at its control input and a clock signal at its clock input to control the switching of FETs 214a and 214b. Power (Vph_pwr) from the buck converter may be connected to charge the battery 22 through the battery FET 222 via the VSYS and CHGOUT terminals of the charging IC 202. The battery FET 222 may serve to monitor the charge current (e.g., using a charge current sense circuit).

In accordance with principles of the present disclosure, the control signal may be internally generated within the charging IC 202 or externally provided to the charging IC. For example, a feedback compensation network comprising various feedback control loops and a comparator 216 may serve as a source of an internally generated control signal. In a particular aspect, the feedback control loops may include an input current sense circuit (e.g., senses input current at USBIN), a charge current sense circuit (e.g., senses current at VSYS and CHGOUT terminals using battery FET 222), a system voltage sense circuit (e.g., senses voltage at VSYS terminal), a battery voltage sense circuit (e.g., senses battery voltage at VBATT terminal), and a battery temperature sense circuit (e.g., senses battery temperature at THERM terminal). In other aspects, the feedback control loops may comprise fewer, or additional, sense circuits. The comparator 216 may produce a reference that serves as the internally generated control signal.

The control signal produced by the comparator 216 is “internal” in the sense that the control signal is generated by circuitry that comprises the charging IC 202. By comparison, a control signal is considered to be “externally” provided when the signal is received from a source external to the charging IC 202, e.g., via the CONTROL terminal of the charging IC. In some aspects, a control selector 216a may be provided to select either the internal control signal generated by the comparator 216 or an externally generated control signal received on the CONTROL terminal to serve as the control signal for the PWM driver circuit.

In accordance with principles of the present disclosure, the clock signal may be internally generated within the charging IC 202 or externally provided to the charging IC. For example, the charging IC 202 may include a clock generator 218 to produce a clock signal (clock out). The clock generator 218 may include a clock generating circuit 218a and a delay element 218b. The clock generating circuit 218a may produce a clock signal that serves as an internally generated clock signal. The delay element 218b may receive an externally provided clock signal.

The clock signal produced by the clock generating circuit 218a is “internal” in the sense that the clock signal is generated by circuitry that comprise the charging IC 202, namely the clock generating circuit. By comparison, a clock signal is considered to be “externally” provided when the signal is received from a source external to the charging IC 202, e.g., via the CLK terminal of the charging IC. In some aspects, a clock selector 218c may be provided to select either the internal clock signal generated by the clock generating circuit 218a or an external clock signal provided on the CLK terminal and delayed (phase shifted) by the delay element 218b to serve as the clock signal for the PWM driver circuit.

The charging IC 202 may include a selector circuit 212 to configure the charging IC to operate in “source” mode or “slave” mode according to the external selection indicator 18 provided on an SEL input of the charging IC. The selection indicator 18 may be a circuit, or a source of an analog signal (e.g., an analog signal generator), a digital signal (e.g., digital logic) or a mechanical or electro-mechanical input. In some aspects, for example, the selection indicator 18 may be an electrical connection to ground potential, either directly or through a resistive element. The selector circuit 212 may operate the control selector 216a and the clock selector 218c according to the selection indicator 18. The selector circuit 212 may also operate a switch 220 to enable or disable sensing of the current input in accordance with the selection indicator 18. It is to be noted that the SEL input can also be a mechanical or electro-mechanical input and may be pre-determined in the mobile device. The SEL input may also be a communication line to other devices.

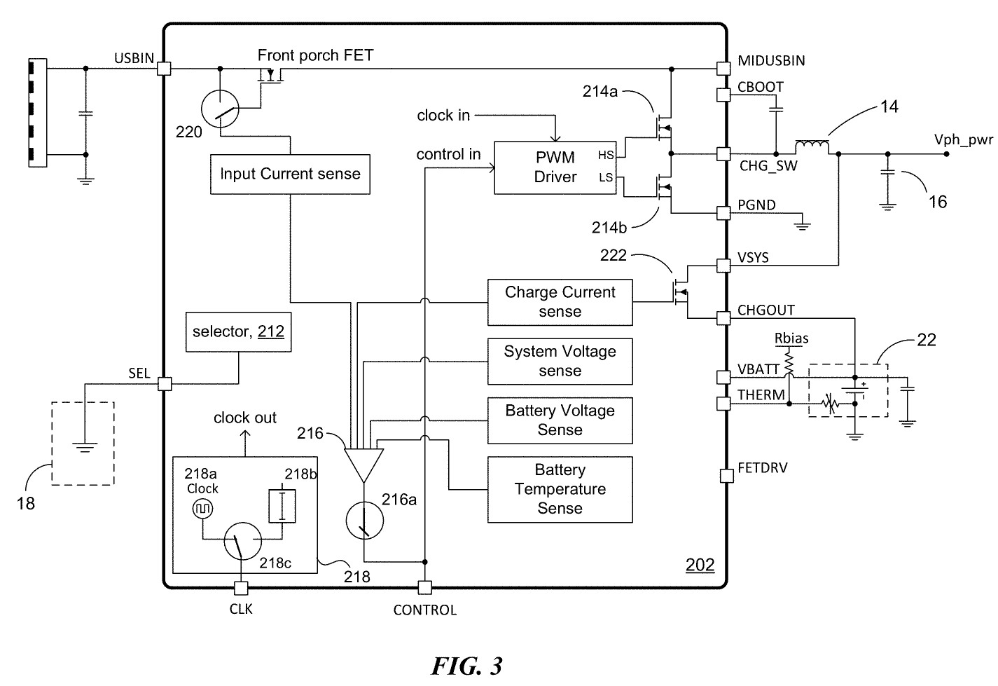

In accordance with the present disclosure, the charging IC 202 may be configured as a single-phase standalone device, or used in parallel or a multiphase configuration. The discussion will first describe a single-phase configuration. FIG. 3 illustrates an example of the charging IC 202 configured to operate as a standalone battery charger. The charging IC 202 may be configured using the SEL input to operate in source mode. In some aspects, source mode operation in the charging IC 202 may be designated by a selection indicator 18 that comprises a connection of the SEL input to ground potential. This convention for designating source mode operation will be used for the remainder of the disclosure with the understanding that, in other aspects, other conventions may be adopted to indicate source mode operation.

In an aspect, the selector 212 may be configured to respond to the presence of a ground connection at the SEL input by configuring the charging IC 202 for source mode operation. For example, the selector 212 may operate the control selector 216a in a first configuration to provide an internally generated control signal to the control input of the PWM driver circuit. The internally generated control signal is also provided to the CONTROL terminal of the charging IC 202, which for the single-phase configuration shown in FIG. 3 is not relevant.

Similarly, the selector 212 may operate the clock selector 218c in a first configuration to provide an internally generated clock signal (e.g., via the clock generating circuit 218a) to the clock input of the PWM driver circuit. The internally generated clock signal is also provided to the CLK terminal of the charging IC 202, which for the single-phase configuration shown in FIG. 3 is not relevant. The selector 212 may also operate the switch 220 to a configuration that enables input current sensing on the power input USBIN.

In operation, the source-mode configured charging IC 202 shown in FIG. 3 operates as a buck converter to charge the battery 22. Feedback control to the PWM driver circuit is provided by the circuitry comprising the charging IC 202, and likewise, the clock signal to the circuit is provided from within the charging IC. The configuration is a “standalone” configuration in the sense that there is only one charging IC.

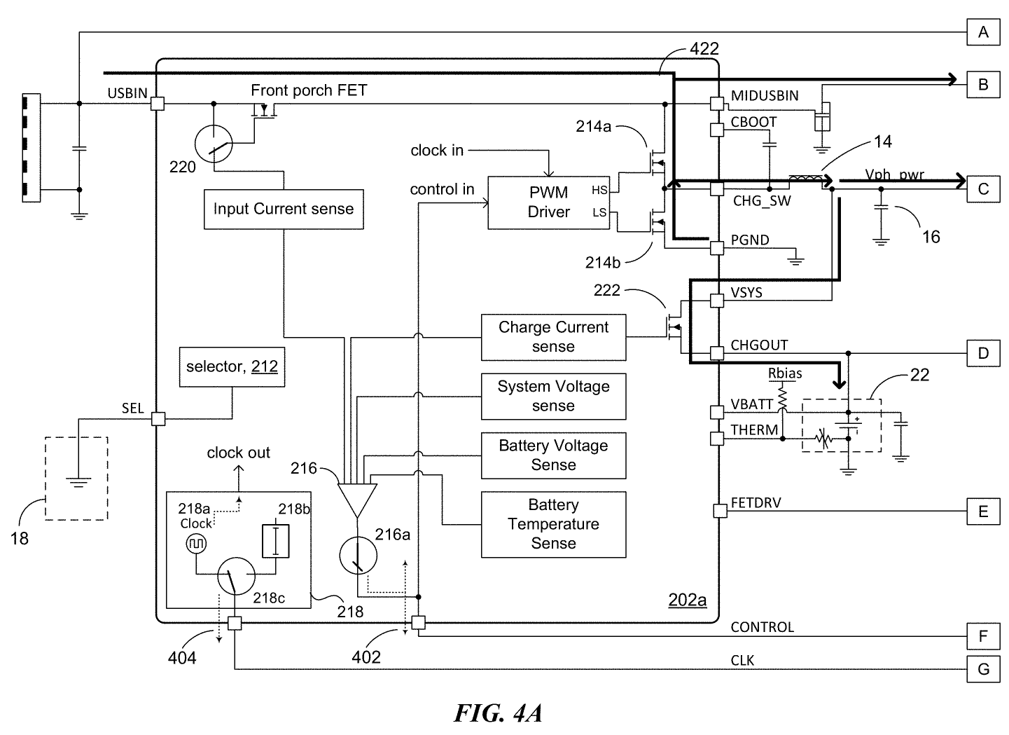

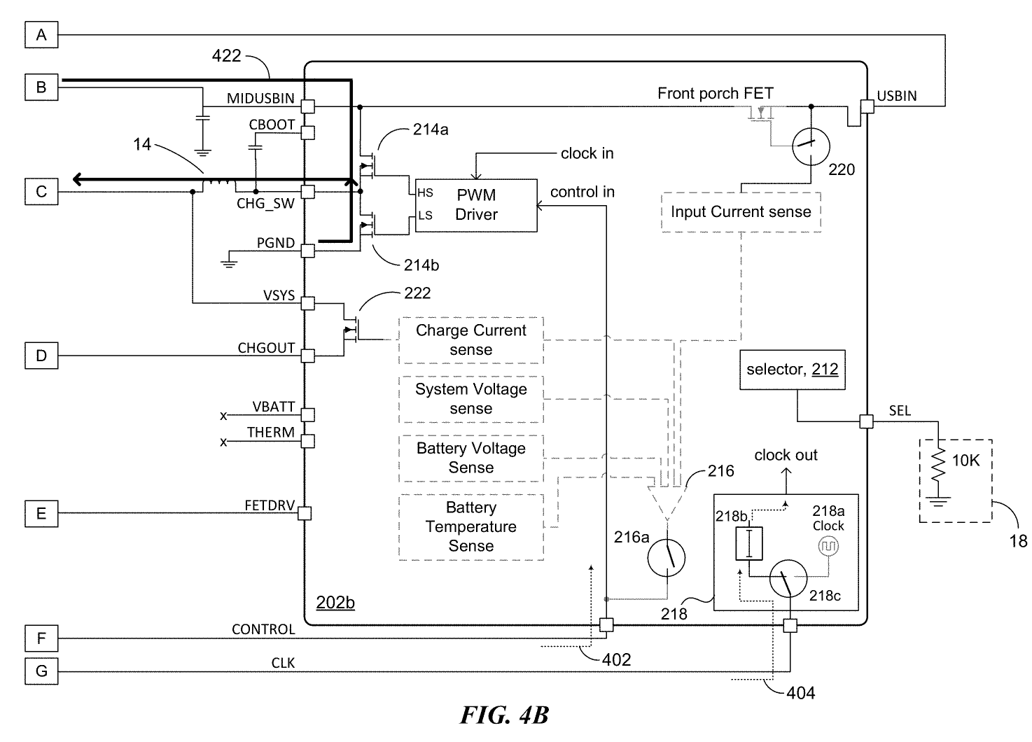

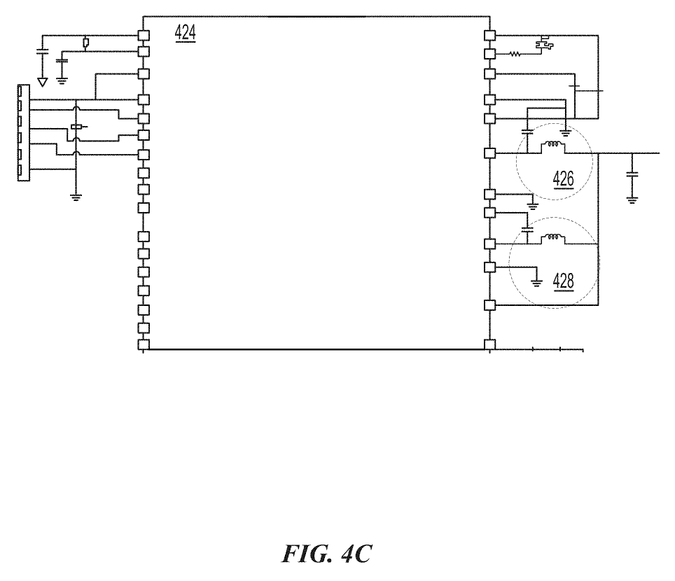

The discussion will now turn to a description of an example of a multiphase configuration of the charging IC 202 in accordance with the present disclosure, and in particular a dual-phase configuration. In a dual-phase configuration, two charging ICs 202 are connected and operate together to charge a battery 22. One of the charging ICs 202 may be configured as a source device and the other as a slave device. FIGS. 4A and 4B show an example of charging ICs 202a and 202b configured to operate respectively as a source device and as a slave device. The charging ICs 202a, 202b are connected together at connections A, B, C, D, E, F, and G. The resulting current flow is illustrated in FIGS. 4A and 4B as flow 422.

The charging IC 202a shown in FIG. 4A is configured for source mode operation as described in FIG. 3. In accordance with the present disclosure, the control signal generated by the comparator 216 in the charging IC 202a is provided as an externally generated control signal 402 (e.g., via the CONTROL terminal), in addition to serving as an internally generated control signal for the PWM driver circuit in the charging IC. Similarly, the clock signal generated by the clock generator 218 is provided as an externally generated clock signal 404 (e.g., via the CLK terminal), in addition to serving as an internally generated clock signal for the PWM driver circuit in the charging IC 202a.

Referring to FIG. 4B, the charging IC 202b is configured for slave mode operation. The charging IC 202b may be configured using the SEL input to operate in slave mode. In some aspects, slave mode operation may be designated by a selection indicator 18 that comprises a resistive element. This convention for designating slave mode operation will be used for the remainder of the disclosure with the understanding that, in other aspects, other conventions may be adopted to indicate salve mode operation. In a particular aspect, for example, a 10K resistor may be used to indicate slave mode operation. It will be appreciated, of course, that another resistance value may be used. The selector 212 may be configured to respond to the detection of a 101KΩ resistance at the SEL input by configuring the charging IC 202b for slave mode operation.

In slave mode operation, the selector 212 may operate the control selector 216a in a second configuration to receive the externally generated control signal 402 that is received on the CONTROL terminal of the charging IC 202b. The control selector 216a provides the externally generated control signal 402 to the control input of the PWM driver circuit. Operation of the control selector 216a in the second configuration disconnects or otherwise effectively disables the feedback network in the charging IC 202b from the PWM driver circuit. This “disconnection” is emphasized in the figure by illustrating the elements of the feedback network in the charging IC 202b using broken grayed out lines.

The selector 212 in the charging IC 202b may also operate the clock selector 218c in a second configuration to receive the externally generated clock signal 404 on the CLK terminal. The clock selector 218c provides the externally generated clock signal 404 to the delay element 218b. The clock signal that is provided to the PWM driver circuit comes from the delay element 218b, thus disconnecting or otherwise effectively disabling the clock generating circuit 218a in the charging IC 202b.

The switch 220 may be configured (e.g., by the selector 212) to disable current sensing at the USBIN terminal of the charging IC 202b. Power to the high- and low-side FETs 214a, 214b may be provided by the MIDUSBIN terminal via connection B. Similarly, charge current sensing in the slave-configured charging IC 202b may be disabled by disabling its battery FET 222.

As can be appreciated from the foregoing description, operation of the PWM driver circuit in the slave-mode charging IC 202b is controlled by the control signal and clock signal that is generated in the source-mode charging IC 202a and provided to the slave-mode charging IC 202b, respectively, as externally generated control and clock signals 402, 404. From the point of view of the slave-mode charging IC 202b, the control and clock signals generated in the source-mode charging IC 202a are deemed to be “externally generated.”

The source-mode charging IC 202a may synchronize with the slave-mode charging IC 202b by asserting a signal on the FETDRV terminal. For example, when the source-mode charging IC 202a pulls the FETDRV terminal LO, the PWM driver circuit in the slave-mode charging IC 202b is disabled. When the source-mode charging IC 202a pull the FETDRV terminal HI, the PWM driver circuit in the slave-mode charging IC 202b begins switching. In some aspects, the FETDRV terminal may be used by the source-mode charging IC 202a to initiate switching in the slave-mode charging IC 202b after the input current rises above a threshold level, in order to balance light-load and heavy-load efficiency. For example, switching losses at light load can outweigh the decreased conduction losses, which can be avoided by not enabling the slave-mode charging IC 202b right away. After enablement, the slave-mode charging IC 202b will operate in synchrony with the clock signal from the source-mode charging IC 202a. Control of the PWM driver circuit in the slave-mode charging IC 202b will be provided by the control signal from the source-mode charging IC 202a, thus allowing the source to set the charge current limit, input current limit, etc.

In accordance with the present disclosure, the delay element 218b may be configured (e.g., by the selector 212) to provide a selectable phase shift that is suitable for dual-phase operation. For example, the delay element 218b may provide a 180° phase shift of the externally generated clock signal 404. Accordingly, the clock signal provided to the clock input of the PWM driver circuit in the slave-mode charging IC 202b is 180° out of phase relative to the clock signal in the source-mode charging IC 202a. Consequently, the charging cycle of the source-mode charging IC 202a will be 180° out of phase relative to the charging cycle of the slave-mode charging IC 202b. For example, when the high-side FET 214a is ON in the source device, the high-side FET in the slave device is OFF, and vice-versa.

The dual-phase configuration of charging circuits shown, for example, in FIGS. 4A and 4B, involves additional source and slave circuits to try to provide the dual-phase charging capabilities. In addition, the charging IC 202 shown in FIG. 3 and the charging ICs 202a and 202b shown in FIGS. 4A and 4B generally operate as a buck converter to charge the battery 22. This additional circuitry, however, may involve additional cost and complexity, for example, to provide communication/synchronization between the charging ICs. For example, the dual-phase charging functionality provided by the charging ICs 202a and 202b shown in FIGS. 4A and 4B involves additional IC and/or external components.

FIG. 4C shows a dual phase implementation in a single IC 424. For example, instead of a master and slave implementation where two different ICs (e.g., master IC and slave IC) are within different devices (e.g., slave and sink devices) in accordance with the dual phase implementation, FIG. 4C illustrates two phases 426 and 428 that are part of a same IC 424 (e.g., integrated into a single monolithic IC).

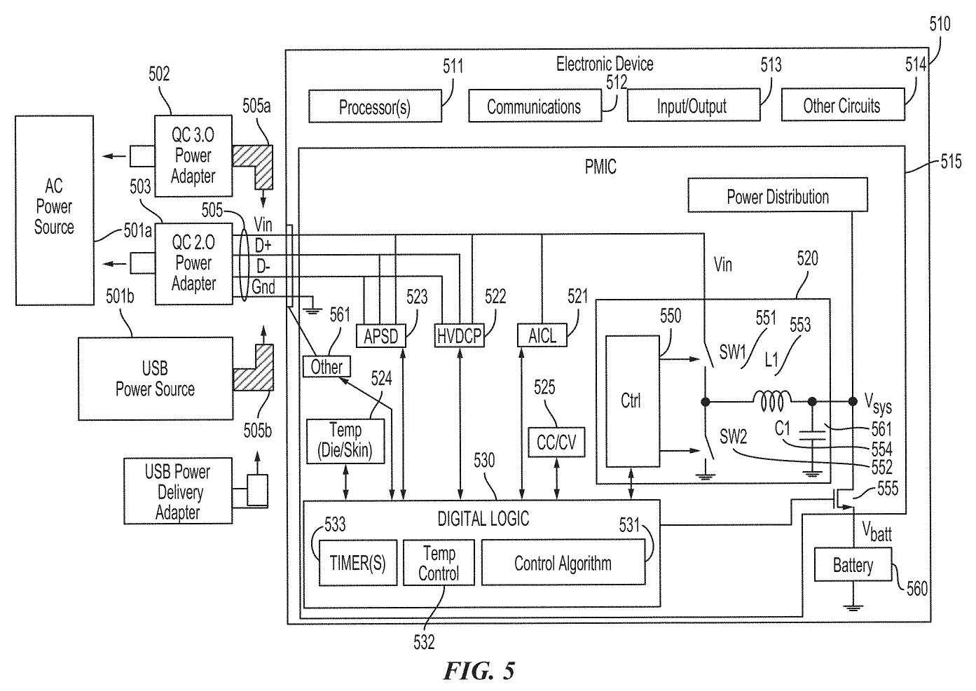

As noted, the slave device determines a current capability (e.g., maximum current capability) of a source or host/source device or external power source and sets an input current limit. An example of an automatic input current limit (AICL) circuit is illustrated in FIG. 5. Although the circuit of FIG. 5 is directed to an external power source, the external power source can be replaced by a source device according to aspects of the present disclosure.

FIG. 5 illustrates an example implementation of an electronic device (e.g., slave or sink device) for implementing an adaptive charging mode according to aspects of the present disclosure. In this example, an electronic device 510 may be coupled to a variety of external power sources 501a and 501b using a USB cable 505 or any other type of protocol (e.g., USB Type-C, USB micro, USB Power Delivery, proprietary connector, or wireless) for connecting sink and source devices according to aspects of the present disclosure. Of course, other high-voltage adapters and low-voltage/high-current adapters can be used. Although the disclosure is directed to external power sources, the power sources may be replaced with peripheral devices configured to operate as source devices to provide charge to the electronic device (e.g., sink device). In one example, an input voltage of 0V to 6V+ is provided and a high input current of 0 A to 10 A+ is provided (not shown).

The USB cable 505 may include a power supply voltage line Vin, a ground (or return) line Gnd, and data lines D+ and D− for carrying data. Some aspects may further include other lines, such as for communicating dedicated configuration information, for example. In this example, the electronic device 510 may be coupled to an AC power source 501a using a Quick Charge 3.0™ power adapter 502 (or equivalent) using a cable 505a, a Quick Charge 2.0™ power adapter 503 (or equivalent) using the cable 505 or using an adapter supporting another high-voltage or low-voltage/high current negotiation process. AC power adapters convert AC power from the AC power source into DC voltage and current. Additionally, the electronic device 510 may be coupled to a USB power source 501b having a configurable DC voltage using a cable 505b. Alternatively, the electronic device 510 may be connected to the source device through a USB Type-C port or other desirable connection protocol.

The electronic device 510 may include a PMIC 515 to provide regulated power supply voltages to one or more processors 511, communications circuits 512, I/O circuits 513, and other circuits 514 as mentioned above. In this example, battery charging circuits are included on a PMIC 515, although in other aspects, battery charging circuits may be on another integrated circuit die, for example. In this example, battery charging circuits include a buck switching regulator 520 (e.g., Vsys is less than Vin), an automatic input current limit (AICL) circuit 521, a high-voltage dedicated charge port (HVDCP) circuit 522, automatic power source detection (APSD) circuit 523, temperature detection circuits 524, controlled current/controlled voltage (CC/CV) circuit 525 and other negotiation implementations devices 561. For example, the other negotiation implementation devices may be according to USB PD, Type C and/or other protocols.

A switching regulator 520 includes a high-side switch 551 and low-side switch 552, which may both be MOS transistors, an inductor 553, an output capacitor 554, and control circuitry 550, which may include pulse width modulation circuits and gate driver circuits to turn switches 551 and 552 ON and OFF, for example. An output of the switching regulator produces a system voltage Vsys, which may be coupled to a battery 560 through a switch transistor 555 during battery charging and coupled to a power distribution circuit to produce regulated voltages for other system circuit blocks. The battery 560 produces voltage Vbatt, which may be coupled through a transistor 555 to provide the system voltage when an external source is not connected, for example. When the external source is not connected, a peripheral device (e.g., OTG peripheral device) may be connected to the electronic device to provide charge to the electronic device. In this case, the electronic device is configured as the sink device while the peripheral device is configured as the source device according to aspects of the present disclosure.

The AICL circuit 521 may determine a maximum current capability of an external power source or the source device configured to provide charge to the electronic device 510. The APSD circuit 523 may determine a type of external power source, for example. The HVDCP circuit 522 may control an external power source or the source device to produce different voltages. The controlled current/controlled voltage (CC/CV) circuit 525 may configure the switching regulator to operate in one or more current control modes (e.g., constant precharge current or fast charge current) and a voltage control mode (e.g., constant “float” voltage charging).

Temperature detection circuits 524 may include analog to digital converters (ADC) or comparators to receive digital or analog temperature sensor signals, respectively, and either translate the digital temperature sensor signals into temperature data or compare the analog temperature sensor signals against reference values to determine if a temperature is above or below one or more thresholds, for example.

In this example, improved charging may be implemented using digital logic 530 in communication with the above-mentioned components. Here, a control algorithm 531 for charging the battery 560 is implemented as part of the digital logic 530. However, it is to be understood that other aspects may implement the methods described using an algorithm operating on a processor in communication with circuit components and configured with software to perform the described techniques. Digital logic 530 may further include timers 533 and temperature control 532. Digital logic 530 may receive temperature information from temperature detection circuits 524. Digital logic 530 may include logic for supporting the APSD circuits 523, AICL circuits 521, and HVDCP circuits 522, for example.

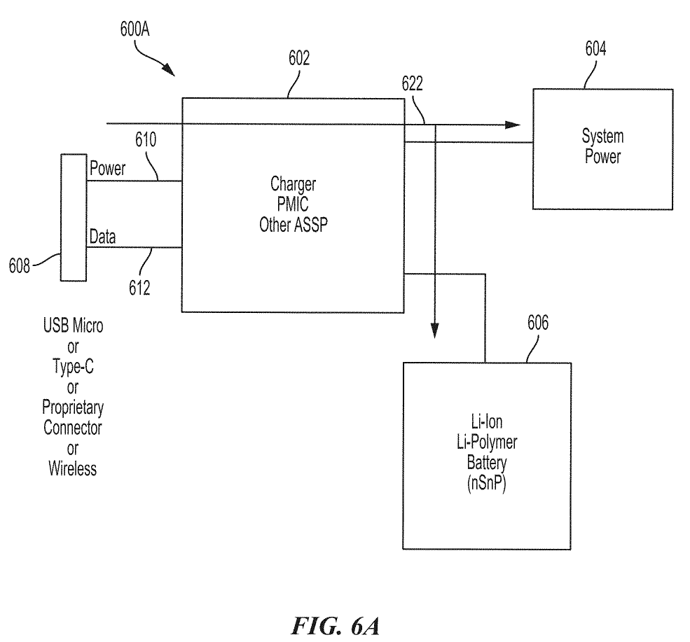

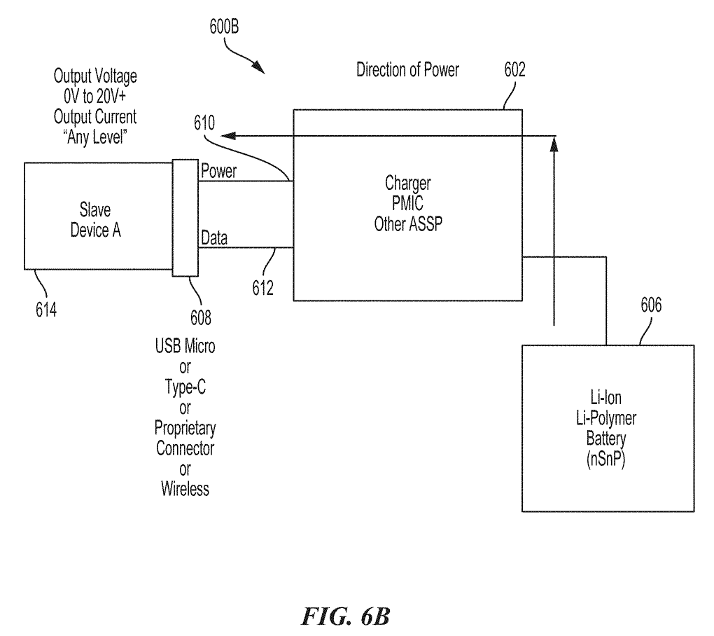

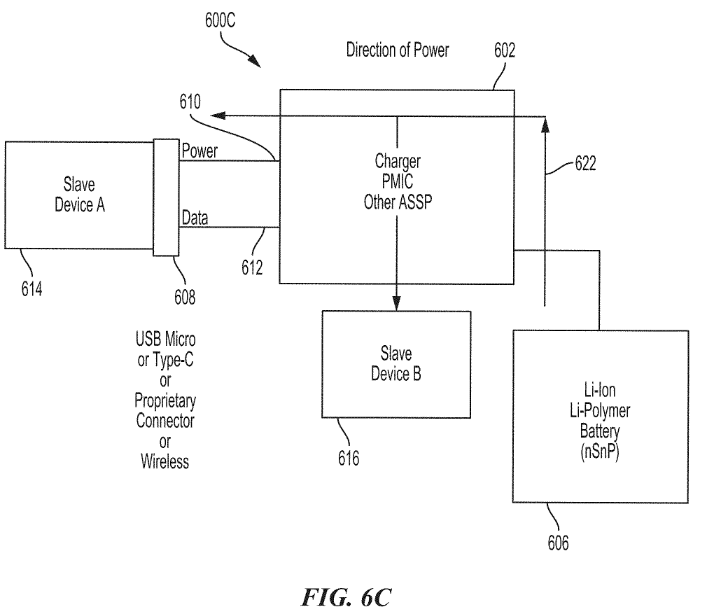

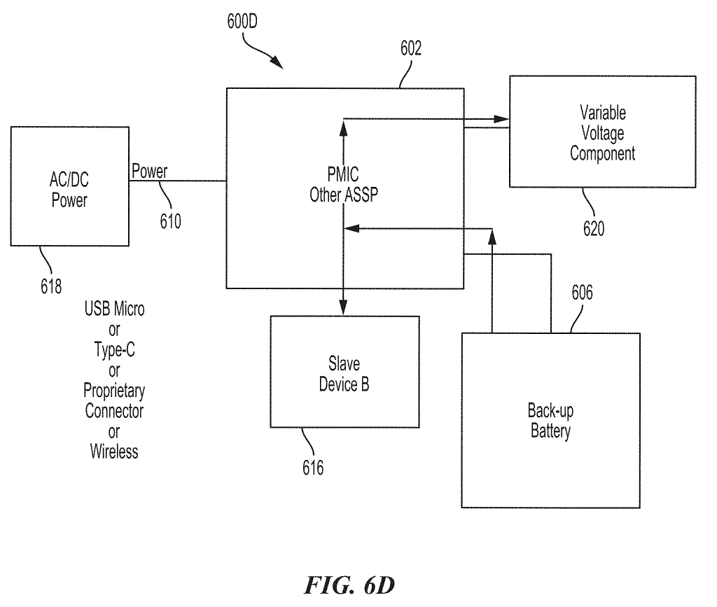

FIG. 6A illustrates a high-voltage or low-voltage/high-current charging system 600A for implementing an adaptive charging mode according to aspects of the present disclosure. The high-voltage or low-voltage/high-current charging system may be implemented in a portable or non-portable device to achieve the adaptive charging mode. The portable or non-portable device may be configured as a sink device or as a source device in accordance with the adaptive charging mode implementation. The portable or non-portable device may be coupled to a peripheral device by a port 608, where the mode of operation (source or sink mode) of the peripheral device and the portable or non-portable device are reconfigurable based on current operating conditions of the peripheral device and/or the portable or non-portable device. The peripheral device may also be a portable or non-portable device.

The high-voltage or low-voltage/high-current charging system 600A includes a charger integrated circuit (including a PMIC) or an application specific standard product (ASSP) 602, system power 604, and a battery 606. A charge (e.g., current, voltage or power) may be provided to the sink device (e.g., the portable or non-portable device) through the port 608. The voltage/current profile configured to be provided to the sink device may have different voltage or current ranges. For example, the voltage/current profile may range from 0-20 V (or higher) with different input current levels, 0V-6V with different input current levels. The voltage/current profile may also include high input current range such as 0 A-10 A (or higher). The voltage profile includes a range of programmable voltages to support different device charge specifications. Charge (e.g., power, voltage, or current) received through the port 608 is provided to the charger integrated circuit 602. The charge is then distributed to the system power 604 and/or to the battery 606.

In some aspects of the disclosure, signals through data lines 612 may be used to negotiate the high-voltage or low-voltage/high-current power to be provided to charge the sink device by a source device while the power is provided through power lines 610. The configuration of the power lines and the data lines may be reconfigurable. The reconfiguration of the data lines and the power lines is based on the configured mode of operation of the devices connected through the port 608. The mode of operation of the devices connected through the port 608 may be dynamically determined by a system controller of one or more of the devices, or a controller integrated with the charger integrated circuit, or a controller that is external but coupled to the charger integrated circuit 602. The determination may also be based on a hardware implementation described herein. When the portable or non-portable device is receiving charge, the charger integrated circuit 602 is in a buck mode of operation. However, when the portable or non-portable device is providing charge, the charger integrated circuit 602 is in a boost, buck, or buck/boost mode of operation.

For example, when the portable or non-portable device is switched from a sink device to a source device, the data lines and the power lines are also switched. Thus, the port is a dynamic port. When the portable or non-portable device is operating as a sink, charge flows through the port to the charger integrated circuit 602 and then is distributed to the system power 604 and the battery 606, in the direction of the arrow 622.

FIG. 6B illustrates a high-voltage or high-current charging implementation 600B for a single sink device according to aspects of the present disclosure. For illustrative purposes, some of the labelling and numbering of the devices and features of FIG. 6B are similar to those of the FIG. 6A. In FIG. 6B, the portable or non-portable device that includes the charging circuit is configured as a source device instead of as a sink device as in FIG. 6A. For example, in FIG. 6B, the battery 606 of the portable or non-portable device provides charge to a single sink device 614 through the charger integrated circuit 602 and the port 608 coupled to the sink device 614b and the charger integrated circuit 602 of the portable or non-portable device.

Thus, instead of using a power adapter as a power source for the sink device, the charger integrated circuit 602 and battery 606 of the source device are used as a power source operating in a boost mode (e.g., reverse boost mode) to charge the sink device 614. For example, power from the battery 606 is fed through the charger integrated circuit 602 and then provided to the sink device 614 to charge the sink device 614. The charger integrated circuit 602 is configured to provide a variable or programmable voltage to the sink device 614 at different current levels. The data and power lines are respectively used to negotiate and provide power to the sink device.

The host device emulates the power profile of a power adapter when in reverse boost, buck or buck/boost mode. That is the V/I profile is emulated. Thus, the sink or peripheral device 614 can detect the true capability of the source device by monitoring behavior of the Vbus line of the USB connector. Alternatively, the V/I profile may be advertised instead of detected. In some implementations, the source device signals to the sink device that its current limit or under-voltage thresholds are attained to let the sink device scale back on power specifications.

FIG. 6C illustrates a high-voltage or high-current charging implementation 600C for multiple sink devices according to aspects of the present disclosure. For illustrative purposes, some of the labelling and numbering of the devices and features of FIG. 6C are similar to those of the FIGS. 6A and 6B. The difference between FIG. 6C and FIG. 6B is that FIG. 6C includes multiple sink devices (614 and 616) that are charged by the charger integrated circuit 602 and battery 606 of the source device, as shown by the arrow 622. The second sink device 616 may be coupled to the source device through a different or similar port as the first sink device 614. The port of the second sink device 616 may or may not be reconfigurable as the port 608.

FIG. 6D illustrates another high-voltage or high-current charging system 600D for non-portable device implementation of an adaptive power transfer mode according to aspects of the present disclosure. Non-mobile devices that are using battery backup may also be able to take advantage of a reverse, programmable power implementation to power specific internal components or external peripherals (e.g., variable voltage component 620) that need variable voltage. Examples may be power amplifiers, displays, connections to outside peripherals that also need higher or variable voltage and current levels, etc. Other adaptive charging implementations take advantage of PMICs, ASSPs or charger ICs, which can reverse power direction and provide a variable voltage and current power capability to power components such as the variable voltage component 620. Such an implementation reduces or eliminates additional components, complexity and board space.

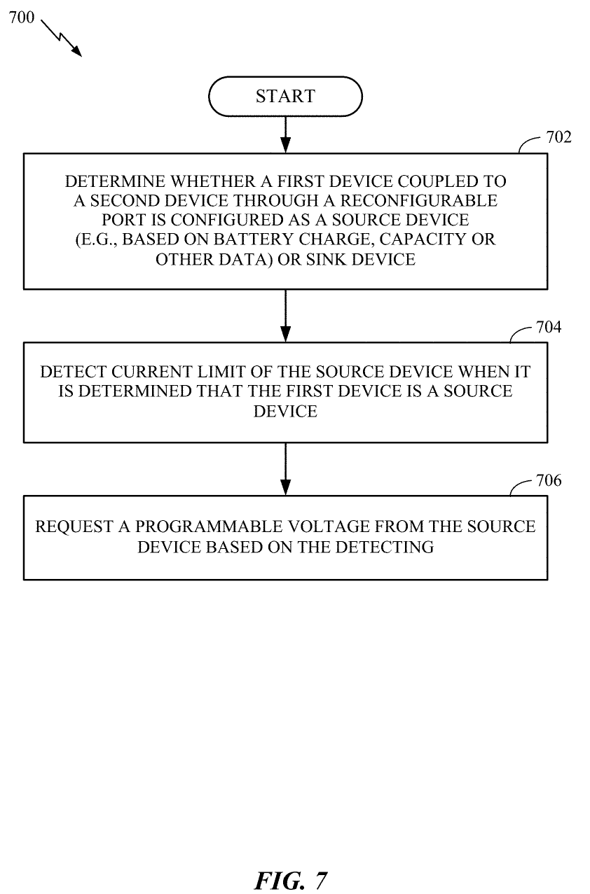

FIG. 7 is a process flow diagram 700 illustrating a method of power management for adaptive charging mode implementation according to an aspect of the present disclosure. In block 702, a portable or non-portable device (e.g., a first device or a second device) determines whether the first device coupled to the second device through a reconfigurable port is configured as a source device. The determination may be based on different criteria. The criteria may be a battery state or charge or other data. For example, the portable or non-portable device is set as a sink device when in an off or in a dead battery state and the peripheral device is coupled to a port of the portable or non-portable device. Thus, power level of the battery may be monitored to determine level of charge of a battery of the portable or non-portable device. A controller or processor of the portable or non-portable device then determines a mode of operation (source or sink) of the portable or non-portable device based on the level of charge of the battery.

In block 704, the portable or non-portable device (e.g., the first device) detects a current limit of the source device. For example, when the first device is configured as a sink device, the sink device (e.g., a controller of the sink device) detects the current limit of the device configured as the source device. In block 706, the portable or non-portable device (e.g., the first device) requests a programmable voltage or programmable amount of power from the source device based on the detecting. For example, when the first device is configured as a sink device, the sink device (e.g., a controller of the sink device) requests the programmable voltage from the source device based on the detecting.

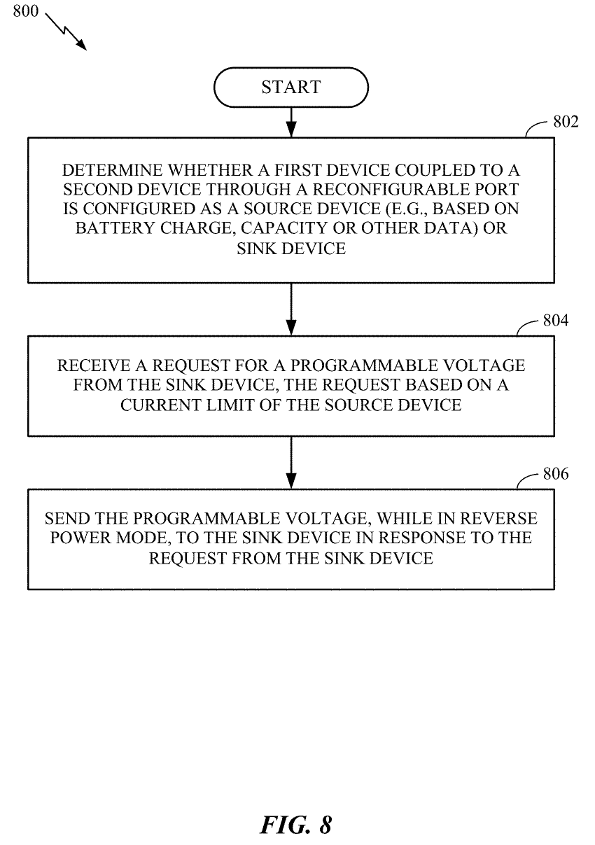

FIG. 8 is a process flow diagram 800 illustrating a method of power management for adaptive charging mode implementation according to an aspect of the present disclosure. In block 802, a portable or non-portable device (e.g., a first device or a second device) determines whether the first device coupled to the second device through a reconfigurable port is configured as a source device. The determination may be based on different criteria. The criteria may be a battery state or charge or other data. For example, the portable or non-portable device is set as a sink device when in an off or in a dead battery state and the peripheral device is coupled to a port of the portable or non-portable device. Thus, power level of the battery may be monitored to determine level of charge of a battery of the portable or non-portable device. A controller or processor of the portable or non-portable device then determines a mode of operation (source or sink) of the portable or non-portable device based on the level of charge of the battery.

In block 804, the portable or non-portable device (e.g., the first device) receives a request for a programmable voltage from the sink device. The request is based on a current limit of the source device. For example, when the first device is configured as a source device, the source device (e.g., a controller of the source device) receives a request for a programmable voltage from the sink device. In block 806, the portable or non-portable device (e.g., the first device) sends the programmable voltage, while in reverse power mode, to the sink device in response to the request from the sink device. For example, when the first device is configured as the source device, the source device (e.g., a controller of the source device) sends the programmable voltage, while in reverse power mode, to the sink device in response to the request from the sink device.

The request is based on the sink device's knowledge of the voltage/current profile or capability of the source device. For example, the sink device may determine the current/voltage capability of the source device based on an AICL implementation. Alternatively, current/voltage capability information of the source device may be provided to the sink device. In other words, the current/voltage capability can be determined by the sink based on source advertising or an output profile. In some implementations, the source device signals to the sink device that its current limit or under-voltage thresholds are attained or met to let the sink device scale back on power specifications.

In some implementations, the charge pump can double the voltage in source mode. For example, a mobile device/user equipment when operating as a power source can optionally enable a divide by two (div/2) charge pump in reverse as a voltage doubler. Thus, reverse boost mode may be used to achieve higher voltages that were not currently available. Using an unregulated charge pump mode to double the voltage (e.g., close to twice the battery voltage (Vbatt)) is more efficient than implementing a charger boost to increase voltage. In addition, the charge pump can halve the voltage in sink mode. The charge pump may be implemented in conjunction with a switching regulator of the portable or non-portable device configured to operate as a charge pump. For example, the charge pump includes a flying capacitor (s) in series with the input capacitors of the switching regulator. The input capacitors and the charge pump capacitors are arranged in parallel with the output capacitor of the switching regulator during switching between two different modes of operation (e.g., switching between buck mode of operation and boost mode of operation). The capacitor(s) of the charge pump serves as an energy-storage element to create either a higher or lower voltage power source.

According to a further aspect of the present disclosure, an adaptive charging mode device has an adaptive charging mode implementation. The adaptive charging mode device includes means for determining whether a first device coupled to a second device through a reconfigurable port is configured as a source device. The determining means may be the battery charging device 102, the charging IC 202, electronic device 510, processor 511, PMIC 515, communication circuits 512, other circuits 514, AICL 521, CC/CV circuit 525, negotiation implementation devices 561, charger PMIC and/or other ASSP 602. The adaptive charging mode device includes means for detecting a current limit of the source device. The detecting means may be the battery charging device 102, the charging IC 202, electronic device 510, processor 511, PMIC 515, communication circuits 512, other circuits 514, AICL 521, CC/CV circuit 525, negotiation implementation devices 561, charger PMIC and/or other ASSP 602. The adaptive charging mode device also includes means for requesting a programmable voltage from the source device based at least in part on the detecting. The requesting means may be the data lines 612, power lines 610, port 608, charger PMIC and/or other ASSP 602, and/or USB cable 505.

The adaptive charging mode device also includes means for receiving a request for a programmable voltage from the sink device. The receiving means may be the data lines 612, power lines 610, port 608, charger PMIC and/or other ASSP 602, and/or USB cable 505. The adaptive charging mode device also includes means for sending the programmable voltage, while in reverse power mode, to the sink device in response to the request from the sink device. The sending means may be the data lines 612, power lines 610, port 608, charger PMIC and/or other ASSP 602, and/or USB cable 505. In another aspect, the aforementioned means may be any module or any apparatus configured to perform the functions recited by the aforementioned means.

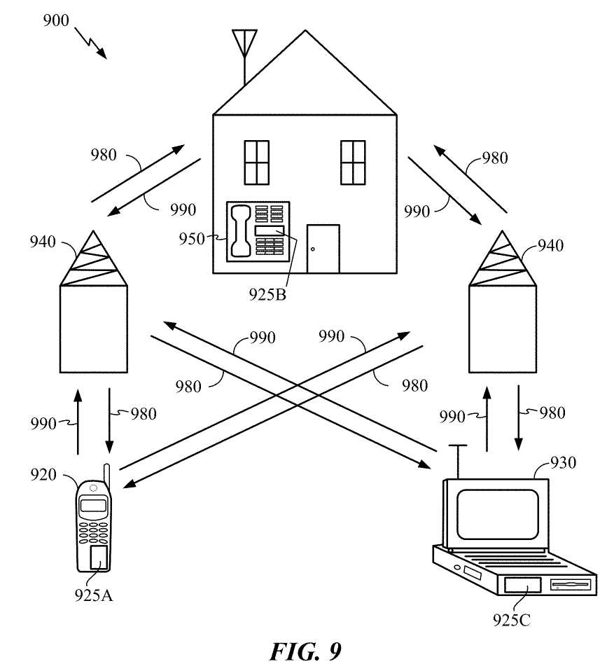

FIG. 9 is a block diagram showing an exemplary wireless communication system 900 in which an aspect of the disclosure may be advantageously employed. For purposes of illustration, FIG. 9 shows three remote units 920, 930, and 950 and two base stations 940. It will be recognized that wireless communication systems may have many more remote units and base stations. Remote units 920, 930, and 950 include IC devices 925A, 925C, and 925B that may include the disclosed adaptive charging mode device. It will be recognized that other devices may also include the disclosed adaptive charging mode device, such as the base stations, switching devices, and network equipment. FIG. 9 shows forward link signals 980 from the base station 940 to the remote units 920, 930, and 950 and reverse link signals 990 from the remote units 920, 930, and 950 to base stations 940.

In FIG. 9, remote unit 920 is shown as a mobile telephone, remote unit 930 is shown as a portable computer, and remote unit 950 is shown as a fixed location remote unit in a wireless local loop system. For example, a remote unit may be a mobile phone, a hand-held personal communication systems (PCS) unit, a portable data unit such as a personal data assistants, a GPS enabled device, a navigation device, a set top box, a music player, a video player, an entertainment unit, a fixed location data unit such as a meter reading equipment, or other devices that store or retrieve data or computer instructions, or combinations thereof. Although FIG. 9 illustrates remote units according to the aspects of the disclosure, the disclosure is not limited to these exemplary illustrated units. Aspects of the disclosure may be suitably employed in many devices, which include the disclosed adaptive charging mode device.

For a firmware and/or software implementation, the methodologies may be implemented with modules (e.g., procedures, functions, and so on) that perform the functions described herein. A machine-readable medium tangibly embodying instructions may be used in implementing the methodologies described herein. For example, software codes may be stored in a memory and executed by a processor unit. Memory may be implemented within the processor unit or external to the processor unit. As used herein, the term “memory” refers to types of long term, short term, volatile, nonvolatile, or other memory and is not to be limited to a particular type of memory or number of memories, or type of media upon which memory is stored.

If implemented in firmware and/or software, the functions may be stored as one or more instructions or code on a computer-readable medium. Examples include computer-readable media encoded with a data structure and computer-readable media encoded with a computer program. Computer-readable media includes physical computer storage media. A storage medium may be an available medium that can be accessed by a computer. By way of example, and not limitation, such computer-readable media can include RAM, ROM, EEPROM, CD-ROM or other optical disk storage, magnetic disk storage or other magnetic storage devices, or other medium that can be used to store desired program code in the form of instructions or data structures and that can be accessed by a computer; disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

In addition to storage on computer readable medium, instructions and/or data may be provided as signals on transmission media included in a communication apparatus. For example, a communication apparatus may include a transceiver having signals indicative of instructions and data. The instructions and data are configured to cause one or more processors to implement the functions outlined in the claims.

Although the present disclosure and its advantages have been described in detail, it should be understood that various changes, substitutions and alterations can be made herein without departing from the technology of the disclosure as defined by the appended claims. For example, relational terms, such as “above” and “below” are used with respect to a substrate or electronic device. Of course, if the substrate or electronic device is inverted, above becomes below, and vice-versa. Additionally, if oriented sideways, above and below may refer to sides of a substrate or electronic device. Moreover, the scope of the present application is not intended to be limited to the particular configurations of the process, machine, manufacture, composition of matter, means, methods and steps described in the specification. As one of ordinary skill in the art will readily appreciate from the disclosure, processes, machines, manufacture, compositions of matter, means, methods, or steps, presently existing or later to be developed that perform substantially the same function or achieve substantially the same result as the corresponding configurations described herein may be utilized according to the present disclosure. Accordingly, the appended claims are intended to include within their scope such processes, machines, manufacture, compositions of matter, means, methods, or steps.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, multiple microprocessors, one or more microprocessors in conjunction with a DSP core, or any other such configuration.

The steps of a method or algorithm described in connection with the disclosure may be embodied directly in hardware, in a software module executed by a processor, or in a combination of the two. A software module may reside in RAM, flash memory, ROM, EPROM, EEPROM, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary designs, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a general-purpose or special-purpose computer. By way of example, and not limitation, such computer-readable media can include RAM, ROM, EEPROM, CD-ROM or other optical disk storage, magnetic disk storage or other magnetic storage devices, or any other medium that can be used to carry or store specified program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD) and Blu-ray disc where disks usually reproduce data magnetically, while discs reproduce data optically with lasers. Combinations of the above should also be included within the scope of computer-readable media.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “a step for.”

1-25. (canceled)

26. A configurable power management apparatus of a first device, comprising:
a first battery;
a power port; and
a charging circuit coupled between the first battery and the power port, the charging circuit configured to operate in a first mode and a second mode, the charging circuit comprising:
a power sink circuit enabled to charge the first battery when an external power adapter is coupled to the power port while the charging circuit is operating in the first mode; and
a power source circuit enabled to generate a programmable output voltage to a second device coupled to the power port while the charging circuit is operating in the second mode.

27. The configurable power management apparatus of claim 26, in which the power source circuit is configured to emulate a voltage/current profile of the external power adapter.

28. The configurable power management apparatus of claim 26, in which the power source circuit is configured:
to receive a request for the programmable output voltage from the second device; and
to output the programmable output voltage to the second device in response to the request for the programmable output voltage from the second device.

29. The configurable power management apparatus of claim 28, in which the request for the programmable output voltage is based at least in part on a current limit of the power source circuit.

30. The configurable power management apparatus of claim 28, in which the charging circuit is configured to advertise a current limit of the power source circuit to the second device.

31. The configurable power management apparatus of claim 28, in which the charging circuit is configured to advertise an under-voltage threshold of the power source circuit to the second device.

32. The configurable power management apparatus of claim 28, in which the power port comprises a USB (universal serial bus) connection with D+/D− data signal connections in addition to power source connections corresponding to VBUS and ground.

33. The configurable power management apparatus of claim 32, in which the first device is configured to receive the request for the programmable output voltage from the second device utilizing either the USB connection with D+/D− data signal connections, the power source connections corresponding to VBUS and ground, or a wireless protocol.

34. The configurable power management apparatus of claim 32, in which the power port comprises a USB Type-C capability to charge another mobile device compatible with the USB Type-C capability.

35. The configurable power management apparatus of claim 32, in which the power port is configured to operate as a dedicated charging port (DCP) by shorting the D+/D− data signal connections after USB battery charging 1.2 protocol detection.

36. The configurable power management apparatus of claim 26, in which the power source circuit is configured to operate in a reverse power mode with a reverse boost mode, a reverse buck mode, a charge pump mode, a bypass mode, a reverse buck/boost mode, or a disabled mode.

37. The configurable power management apparatus of claim 36, in which the power source circuit is configured to determine the reverse power mode based at least in part on a current operating condition of the first device and/or the second device including a state of charge of the first battery and/or of a second battery in the second device, a first battery voltage of the first device and/or a second battery voltage of the second device, a first battery capacity of the first device and/or a second battery capacity of the second device, a priority of the first device and/or the second device, a charge current to be supplied to the first device or a second device, cable compensation for an impedance of a power supply path between the first device and the second device, or a thermal condition of the first device and/or the second device.

38. A configurable power management method, comprising:
charging a first battery by a reconfigurable charging circuit of a first device coupled between the first battery and a power port when an external power adapter is coupled to the power port while the reconfigurable charging circuit is operating in a first mode; and
generating, by the reconfigurable charging circuit, a programmable output voltage for a second device coupled to the power port while the reconfigurable charging circuit is operating in a second mode.

39. The configurable power management method of claim 38, in which the reconfigurable charging circuit is configured as a power sink to charge the first battery while operating in the first mode and the reconfigurable charging circuit is configured as a power source to generate the programmable output voltage while operating in the second mode.

40. The configurable power management method of claim 38, in which a request for the programmable output voltage is based at least in part on a current limit of the reconfigurable charging circuit while operating in the second mode.

41. The configurable power management method of claim 38, further comprising:
receiving a request for the programmable output voltage from the second device when the reconfigurable charging circuit is operating in the second mode; and
outputting the programmable output voltage to the second device in response to the request for the programmable output voltage from the second device.

42. The configurable power management method of claim 41, further comprising advertising a current limit of the reconfigurable charging circuit to the second device while operating in the second mode.

43. The configurable power management method of claim 41, further comprising advertising an under-voltage threshold of the reconfigurable charging circuit to the second device while operating in the second mode.

44. The configurable power management method of claim 41, in which the power port comprises a USB (universal serial bus) connection with D+/D− data signal connections in addition to power source connections corresponding to VBUS and ground.

45. The configurable power management method of claim 44, further comprising receiving the request for the programmable output voltage from the second device utilizing either the USB connection with D+/D− data signal connections, the power source connections corresponding to VBUS and ground, or a wireless protocol.

46. The configurable power management method of claim 44, further comprising operating the power port as a dedicated charging port (DCP) by shorting the D+/D− data signal connections after USB battery charging 1.2 protocol detection.

47. The configurable power management method of claim 38, further comprising operating the reconfigurable charging circuit in a reverse power mode with a reverse boost mode, a reverse buck mode, a charge pump mode, a bypass mode, a reverse buck/boost mode, or a disabled mode.

48. The configurable power management method of claim 47, further comprising determining the reverse power mode when the reconfigurable charging circuit is operating in the second mode based at least in part on a current operating condition of the first device and/or the second device including a state of charge of the first battery and/or of a second battery in the second device, a first battery voltage of the first device and/or a second battery voltage of the second device, a first battery capacity of the first device and/or a second battery capacity of the second device, a priority of the first device and/or the second device, a charge current to be supplied to the first device or the second device, a cable compensation for an impedance of a power supply path between the first device and the second device, or a thermal condition of the first device and/or the second device.

49. A configurable power management apparatus of a first device, comprising:
a battery;
a power port;
means for charging the battery when an external power adapter is coupled to a power port of the battery while the battery charging means is operating in a first mode; and
means for generating a programmable output voltage to a second device coupled to the power port while the battery charging means is operating in a second mode.

50. The configurable power management apparatus of claim 49, in which the battery charging means further comprises:
means for receiving a request for the programmable output voltage from the second device; and
means for outputting the programmable output voltage to the second device in response to the request for the programmable output voltage from the second device.
